(19) United States
(12) Patent Application Publication
(10) Pub. No.: US 2008/0298878 A1
(43) Pub. Date: Dec. 4, 2008

(54) MARKER WITH A SEAL ARRANGEMENT

(76) Inventor: Ve Chung Hui, Hong Kong (CN)

Correspondence Address: RABIN & Berdo, PC, 1101 14TH STREET, NW, SUITE 500, WASHINGTON, DC, 20005, US

(21) Appl. No.: 12/127,947

(22) Filed: May 28, 2008

(30) Foreign Application Priority Data
May 28, 2007 (CN) 200720120371.9

(51) Int. Cl. B43K 5/16

(52) U.S. Cl. 401/108; 401/107

(57) ABSTRACT

The invention relates to a marker with a seal arrangement, comprising a housing in which an ink storage chamber, a spring system, a writing tip connected to an end portion of the ink storage chamber, and a seal arrangement fitted onto the outer periphery of an end of the writing tip are disposed. The seal arrangement comprises a frame portion and a sealing chamber fixed on the frame portion. The sealing chamber has an opening at its front end for the writing tip to protrude and retract, the frame portion is fixed at its front end with one end of a tough and flexible sealing strip which has the other end fixed on a hooked block formed at the front end of the ink storage chamber, the sealing strip further comprising an aperture capable of closing and exposing the opening of the sealing chamber.

### FIELD OF THE INVENTION

The present invention relates to stationery, more particularly, relates to a marker with a seal arrangement.

### BACKGROUND OF THE INVENTION

Presently, volatile ink is used in various writing instruments such as water-color pens, fountain pens, felt-tipped pens and ballpoint pens. The ink will become dry and coagulate to get the writing tip choked when the writing tip is exposed to air for a long time. Most of the pens available in the market are provided with pen caps. With these caps, evaporation of ink is not easy to take place to some extent. However, this kind of pen caps is not suitable for propelling/retractable writing instruments. Thus there is a need for a novel seal arrangement for use in pens.

### SUMMARY OF THE INVENTION

In view of the above, it is an object of the present invention to provide a marker with a seal arrangement, which overcome the drawbacks that the currently available pens have poor air-tightness and the ink is prone to evaporate.

This object is achieved by providing a marker with a seal arrangement comprising a housing in which an ink storage chamber, a spring system, a writing tip connected to an end portion of the ink storage chamber, and a seal arrangement fitted onto the outer periphery of an end of the writing tip are disposed, wherein the seal arrangement comprises a frame portion and a sealing chamber fixed on the frame portion, the sealing chamber has an opening at its front end for the writing tip to protrude and retract, the frame portion is fixed at its front end with one end of a tough and flexible sealing strip which has the other end fixed on a hooked block formed at the front end of the ink storage chamber, the sealing strip further comprising an aperture that is capable of closing and exposing the opening of the sealing chamber along with elongation and contraction of the sealing strip.

Preferably, the frame portion is provided with a flange, and the housing is provided with a stop against a rear end surface of the flange. The housing is further provided with a movement limiting portion against a front end surface of the flange.

According to a preferred-embodiment of the present invention, the writing tip is provided with a protrusive portion which cooperates with a rear end of the sealing chamber.

Preferably, the ink storage chamber comprises a cotton core sleeve, a cotton core arranged within the sleeve, and an end cover for closing an end of the sleeve. Particularly, the hooked block is disposed at the front end of the sleeve.

Preferably, the frame portion is further provided with a guiding hole through which the sealing strip passes.

The marker with a seal arrangement of the present invention is particularly suitable for use in propelling/retractable writing instruments, providing effective protection for the writing tip from being choked due to drying of ink, and allowing the writing tip to protrude smoothly.

### BRIEF DESCRIPTION OF THE DRAWINGS

A preferred embodiment of the present invention will be described below only by way of example, with reference to the annexed figures, in which:

FIG. 1 is an exploded view of a marker with a seal arrangement constructed in accordance with the present invention;

FIG. 2 is a schematic diagram of the marker of FIG. 1 with the writing tip in its retracted position;

FIG. 3 is a cross-sectional view taken along line A-A of FIG. 2;

FIG. 4 is an enlarged view of part C of FIG. 3;

FIG. 5 is a schematic diagram of the marker of FIG. 2 with the writing tip in its protruded position;

FIG. 6 is a cross-sectional view taken along line B-B of FIG. 5.

### DETAILED DESCRIPTION OF THE PREFERRED EMBODIMENT

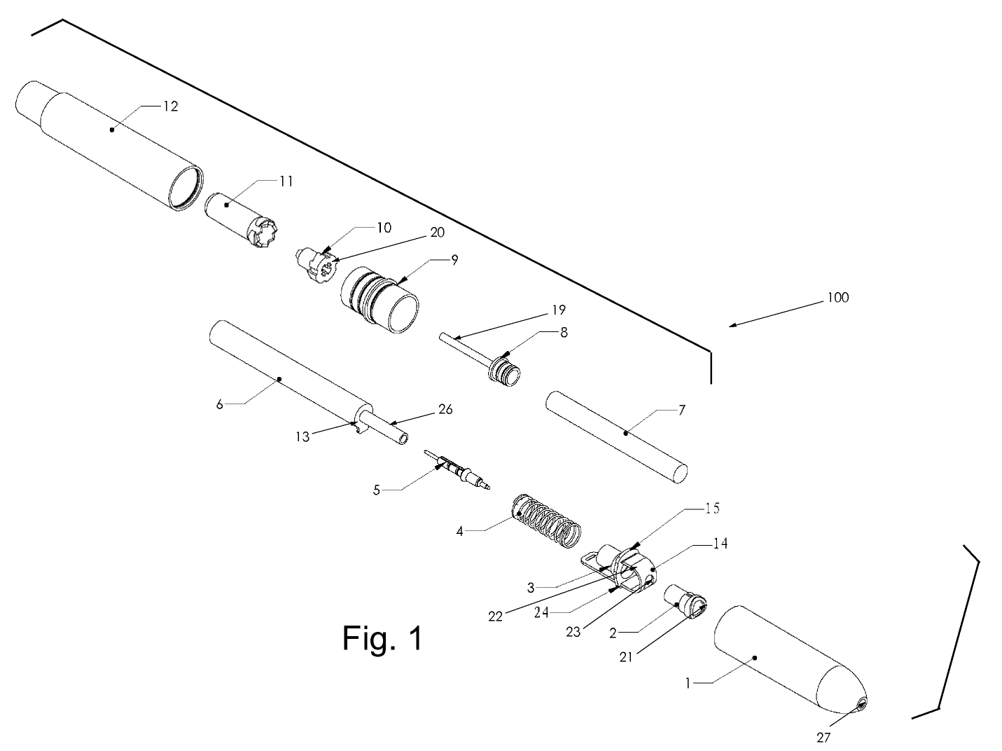

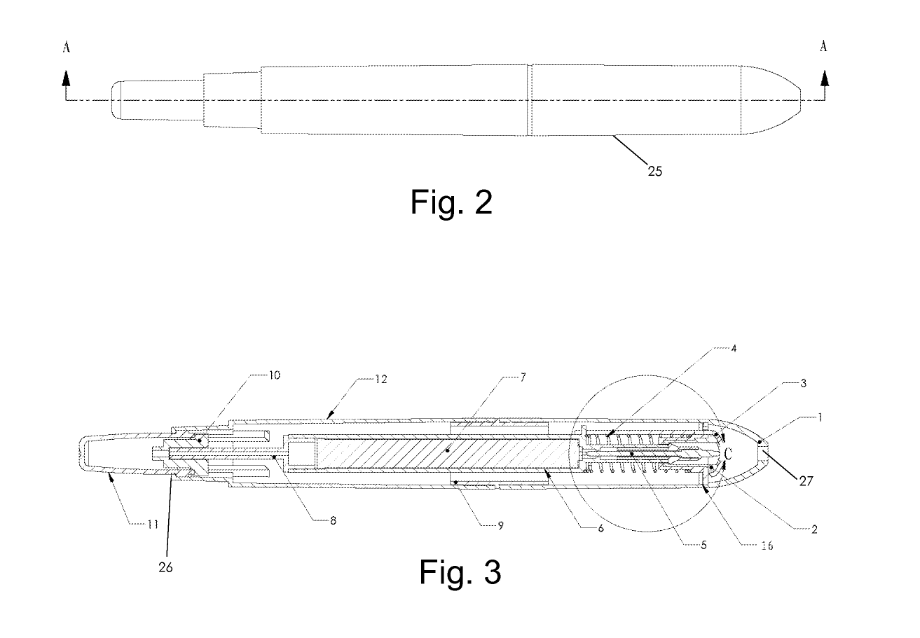

With reference to FIG. 1 to FIG. 3, a marker 100 with a seal arrangement comprises a housing 25 which can be formed as a single piece or formed with a rear shell 12 and a front shell 1 connected to the rear shell 12 in a threading manner or in a snap-fit manner or other connecting means well known in the art. In this embodiment connection of the rear shell 12 and the front shell 1 is achieved by arranging a middle section 9 therebetween in a way that they are connected to the ends of the middle section 9 respectively. An ink storage chamber, a bounce mechanism which is brought into abutment with the ink storage chamber, a writing tip 5 connected to an end portion of the ink storage chamber, and a seal arrangement fitted onto the outer periphery of an end of the writing tip 5 are all housed in the housing 25. The housing 25 has a first bore 26 in the vicinity of the end of the bounce mechanism; and a second bore 27 in the vicinity of the end of the writing tip 5, in order to allow the writing tip 5 to protrude.

The bounce mechanism comprises a plunger 11 extending out from the first bore 26 of the housing 25, and a bouncing member 10 that cooperates with the plunger 11. The plunger 11 includes evenly distributed small bumps, and the bouncing member 10 has corresponding slots for engaging with the bumps in a ratchet-like manner. Pressing the plunger 11, the bumps are engaged snugly with the slots in sequence to make the bouncing member 10 move forward, or retract or hold in place. The plunger 11 and the bouncing member 10 can be of any other configuration known in the art. This is not a part of the invention and therefore not described in detailed.

The ink storage chamber comprises a cotton core sleeve 6, a cotton core 7 arranged within the sleeve 6, and an end cover 8 for closing an end of the sleeve 6. The end cover 8 is brought into abutment with the bouncing member 10. Preferably, the end cover 8 is provided with a thin rod 19 that cooperates with a recess 20 formed on the bouncing member 10 for better positioning. The writing tip 5 is communicated with the sleeve 6 for conduction of the ink through a guiding tube 26 disposed at a front end of the sleeve 6. The front end of the sleeve 6 is further provided with a hooked block 13.

The bounce mechanism further comprises a spring member disposed between the ink storage chamber and the seal arrangement. In this embodiment, the spring member is a coiled spring 4 disposed around the guiding tube 26. The spring force of the coiled spring brings the bounce mechanism into close abutment with the ink storage chamber as well as with the seal arrangement.

The seal arrangement is securely arranged inside the housing 25, comprising a frame portion 3, and a sealing chamber 2 fixed on the frame portion 3. The frame portion 3 has an aperture 22 at its rear end for the writing tip 5 to extend into the sealing chamber 2. The sealing chamber 2 is of cylindrical configuration and made of flexible material, having an opening 21 at its front end for the writing tip 5 to protrude and retract. The front end of the sealing chamber 2 takes shape of arc in order to provide better sealing. The frame portion 3 (is fixed with a sealing strip 14 at its front end for exposing and closing the opening 21 of the sealing chamber 2. The sealing strip 14 is made of flexible and tough material so that it is able to elongate when an external force is applied and to contract when the force is released. The sealing strip 14 has one end fixed on the frame portion and the other end which passes through a guiding hole 24 formed on the frame portion 3 to be fixed on the hooked block 13 at the front end of the sleeve 6. The sealing strip 14 may elongate or contract along with forward or backward movements of the sleeve 6, allowing for change of the position of an aperture 23 formed on the sealing strip 14 so that the opening 21 of the sealing chamber 2 is exposed or closed by the sealing strip 14. The writing tip 5 is provided with a protrusive portion 18 which cooperates with a rear end of the sealing chamber 2. When the writing tip 5 retracts, the protrusive portion 18 is able to tightly mate with the rear end of the sealing chamber 2 under the action of the coiled spring 4, thereby the rear end of the sealing chamber 2 is airtight.

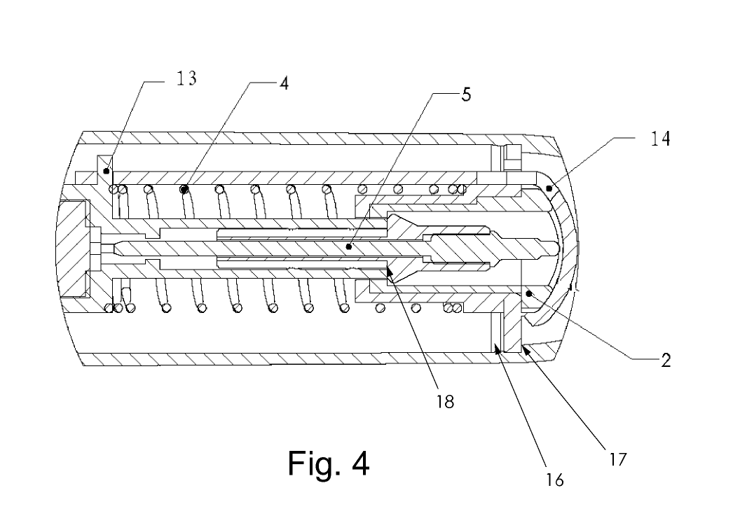

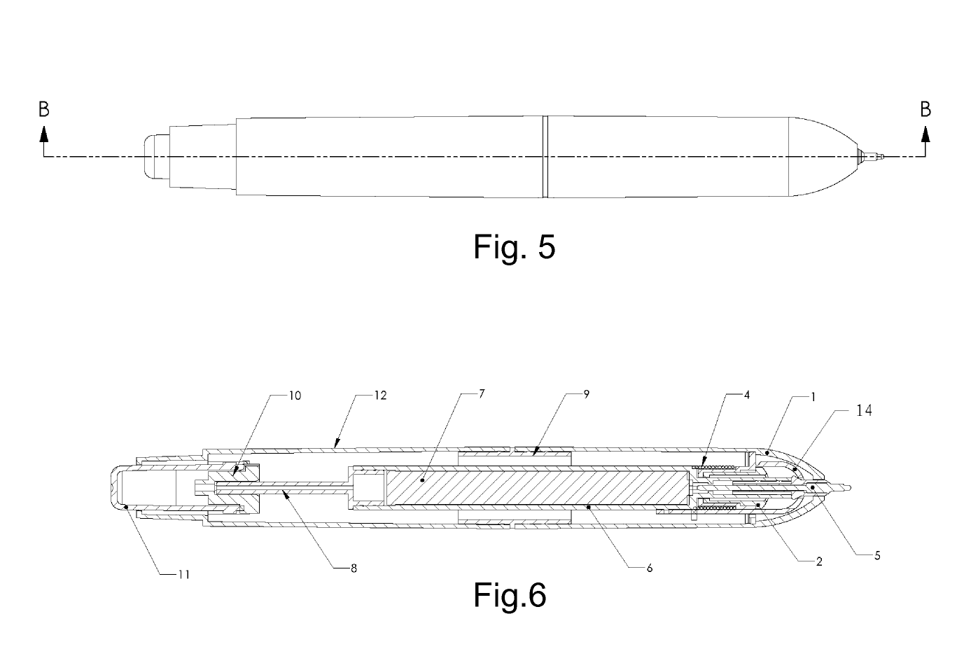

With reference to FIG. 4 and FIG. 5, in order to secure the seal arrangement, the frame portion 3 is provided with a flange 15, and the housing 25 is provided with a stop 16 against a rear end face of the flange 15 so as to restrict backward movement of the seal arrangement. The housing 25 is further provided with a movement limiting portion 17 against a front end face of the flange 15 so as to restrict forward movement of the seal arrangement.

When the plunger 11 of the bounce mechanism is pressed for the writing tip 5 to retract, the spring force of the coiled spring 4 is reduced to allow the writing tip 5 to retract and be positioned in the sealing chamber 2 of the seal arrangement. While the sleeve 6 moves backward to pull the sealing strip 14 by use of the hooked block 13. With the toughness and flexibility of the sealing strip 14, the aperture 23 of the sealing strip 14 biases the opening 21 at the front end of the sealing chamber 2, thereby the sealing chamber 2 is sealed.

With reference to FIG. 6, when the plunger 11 is pressed again for the writing tip 5 to protrude, the spring force of the coiled spring 4 is increased to allow the writing tip 5 to move forward. While the sleeve 6 also moves forward, and the pulling force of the hooked block 13 on the sealing strip 14 is diminished. Consequently, the sealing strip 14 contracts and restores to its original position, thereby the aperture 23 of the sealing strip 14 is aligned with the opening 21 at the front end of the sealing chamber 2 to allow the writing tip 5 protrude.

Unlike conventional writing instruments, the marker with a seal arrangement according to the present invention is particularly suitable for propelling/retractable writing instruments, providing effective protection for the writing tip from being choked due to drying of ink, and allowing the writing tip to protrude smoothly.

What is claimed is:

1. A marker with a seal arrangement, comprising a housing (25) in which an ink storage chamber, a bounce mechanism, a writing tip (5) connected to an end portion of the ink storage chamber, and a seal arrangement fitted onto the outer periphery of an end of the writing tip (5) are disposed, characterized in that the seal arrangement comprises a frame portion (3) and a sealing chamber (2) fixed on the frame portion (3), the sealing chamber (2) has an opening (21) at its front end for the writing tip (5) to protrude and retract, the frame portion (3) is fixed at its front end with one end of a tough and flexible sealing strip (14) which has the other end fixed on a hooked block (13) formed at the front end of the ink storage chamber, the sealing strip (14) further comprising an aperture (23) that is capable of closing and exposing the opening (21) of the sealing chamber (2) along with elongation and contraction of the sealing strip (14).

2. The marker with a seal arrangement according to claim 1, characterized in that the frame portion (3) is provided with a flange (15), and the housing (25) is provided with a stop (16) against a rear end face of the flange (15).

3. The marker with a seal arrangement according to claim 2, characterized in that the housing (25) is further provided with a movement limiting portion (17) against a front end face of the flange (15).

4. The marker with a seal arrangement according to claim 1, characterized in that the writing tip (5) is provided with a protrusive portion (18) which cooperates with a rear end of the sealing chamber (2).

5. The marker with a seal arrangement according to claim 1, characterized in that the ink storage camber comprises a cotton core sleeve (6), a cotton core (7) arranged within the sleeve (6), and an end cover (8) for closing an end of the sleeve (6).

6. The marker with a seal arrangement according to claim 5, characterized in that the hooked block (13) is disposed at the front end of the sleeve (6).

7. The marker with a seal arrangement according to claim 1, characterized in that the frame portion (3) is further provided with a guiding hole (24) through which the sealing strip (14) passes.
